(19) United States
(12) Patent Application Publication
(10) Pub. No.: US 2005/0168933 A1
(43) Pub. Date: Aug. 4, 2005

(54) Damping device for hard disk drive

(76) Inventor: Dennis Lee, San Chung City (TW)

Correspondence Address: TROXELL LAW OFFICE PLLC;SUITE 1404, 5205 LEESBURG PIKE, FALLS CHURCH, VA, 22041, US

(21) Appl. No.: 10/770,528

(22) Filed: Feb. 4, 2004

(51) Int. Cl. G11B 17/03; G06F 1/16

(52) U.S. Cl. 361/685; 720/611; 248/633; 248/634; 248/636; 248/638; 248/618; 369/80

(57) ABSTRACT

A damping device for hard disk drive includes two elastic cushion pads for connecting to two lateral sides of a hard disk drive. Each cushion pad includes a main body slightly thicker than the hard disk drive, and at least an upper and a lower metal reinforcing strip separately embedded in the main body. The main body is provided on an outer side facing toward a computer case with at least two upper and two lower mounting holes. One set of screws are threaded through the lower mounting holes and the lower reinforcing strip to connect the cushion pad to each lateral side of the hard disk drive, and another set of screws are threaded through mounting slots provided on an inner wall of the computer case into the upper mounting holes to engage with the upper reinforcing strip and thereby fix the hard disk drive with the damping device onto the computer case.

### FIELD OF THE INVENTION

The present invention relates to a damping device for hard disk drive, and more particularly to a damping device having two cushion pads for connecting to two lateral sides of a hard disk drive and two separate metal reinforcing strips embedded in each of the cushion pads to effectively reduce vibration and noise produced by the hard disk drive during operation thereof.

### BACKGROUND OF THE INVENTION

A hard disk drive operates to store data in continuously rotating disks, and store data files in folders or directories. The hard disk drive is mounted in a computer case and includes a large number of constantly rotating disks. When the hard disk drive operates, it produces vibration that would be transferred to the computer case and produces noises.

To reduce the noises produced by the operating hard disk drive, the hard disk drive is usually provided with a damping device that absorbs the vibration and thereby reduces the noises. Such damping device for hard disk drive is mainly in the form of cushion pads made of an elastic material, such as silicon rubber. The cushion pads are mounted between the hard disk drive and a computer case to absorb the vibration produced by the operating hard disk drive and to prevent the vibratory force from transferring to the computer case to produce noises.

Since the cushion pad made of silicon rubber is resilient and soft, it has insufficient structural strength to bear the vibratory force. As a remedy, this type of cushion pad usually has a metal reinforcing member embedded therein in order to obtain better vibratory-force bearing ability. Most of conventional metal reinforcing members embedded in the cushion pad of the damping device for hard disk drive are integrally formed one-piece member. While the one-piece metal reinforcing member effectively increases the stiffness of the damping device for hard disk drive, it also reduces the elasticity and vibration-absorbing ability of the cushion pad.

FIG. 1 shows a cross section of a first conventional damping device for hard disk drive. The damping device has a cushion pad 10 made of silicon rubber and in the form of a long bar having a substantially rectangular cross section. A reinforcing member 11 integrally formed from a metal material is embedded in a central portion of the cushion pad 10. When the damping device for hard disk drive is mounted between the hard disk drive and an inner wall of the computer case, vibration produced by the operating hard disk drive is absorbed by the cushion pads 10. The metal reinforcing members 11 embedded in the cushion pads 10 serve to increase the structural strength and force-bearing ability of the cushion pads 10.

In the first conventional damping device for hard disk drive, the integrally formed reinforcing member 11 embedded in the cushion pad 10 has a substantially H-shaped cross section. That is, the whole H-sectioned reinforcing member 11 and the cushion pad 10 are subjected to the vibratory force at the same time. The cushion pad 10 with this force-bearing structure has improved structural strength but reduced elasticity and vibration-absorbing ability. As a result, the function of the cushion pad in preventing noises is largely adversely affected.

FIG. 2 is a cross sectional view of a second conventional damping device for hard disk drive. In the cushion pad of this type of damping device for hard disk drive, a substantially U-sectioned reinforcing member 12 is embedded in the cushion pad. As in the case of the first damping device for hard disk drive, the cushion pad and the embedded reinforcing member 12 of the second damping device are subjected to the vibratory force at the same time and would therefore reduce the vibration-absorbing and noise-preventing ability of the second damping device for hard disk drive.

### SUMMARY OF THE INVENTION

A primary object of the present invention is to provide a damping device for hard disk drive that includes reinforcing members enabling the damping device to effectively reduce the vibration and noises produced by an operating hard disk drive.

To achieve the above and other objects, the damping device for hard disk drive according to the present invention includes two cushion pads made of an elastic material for connecting to two lateral sides of a hard disk drive. Each of the two cushion pads includes a main body having an outer side for abutting on an inner wall of a computer case, an inner side for abutting on one lateral side of the hard disk drive, and a height slightly larger than a thickness of the hard disk drive, and at least an upper and a lower reinforcing strip made of a metal material separately embedded in the main body. The main body is provided on the outer side with at least two spaced upper mounting holes and two spaced lower mounting holes corresponding to holes formed on the upper and the lower reinforcing strips, respectively. One set of screws are threaded through the lower mounting holes and the lower reinforcing strip of each cushion pad to connect the cushion pad to one lateral side of the hard disk drive, and another set of screws are threaded through mounting slots provided on the inner wall of the computer case into the upper mounting holes to engage with the upper reinforcing strip.

In a preferred embodiment of the present invention, the upper reinforcing strip is shorter and located closer to the outer and the top side of the main body of the cushion pad, and the lower reinforcing strip is longer and located closer to the inner and the bottom side of the main body of the cushion pad.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a cross sectional view of a first conventional damping device for hard disk drive;

FIG. 2 is a cross sectional view of a second conventional damping device for hard disk drive;

FIG. 3 is an exploded perspective view of a damping device for hard disk drive according to a preferred embodiment of the present invention;

FIG. 4 is a cross sectional view of a cushion pad of the damping device of FIG. 3;

FIG. 5 shows a hard disk drive with the damping device of the present invention is ready for mounting in a computer case; and

FIG. 6 shows the hard disk drive with the damping device of the present invention has been screwed to the computer case.

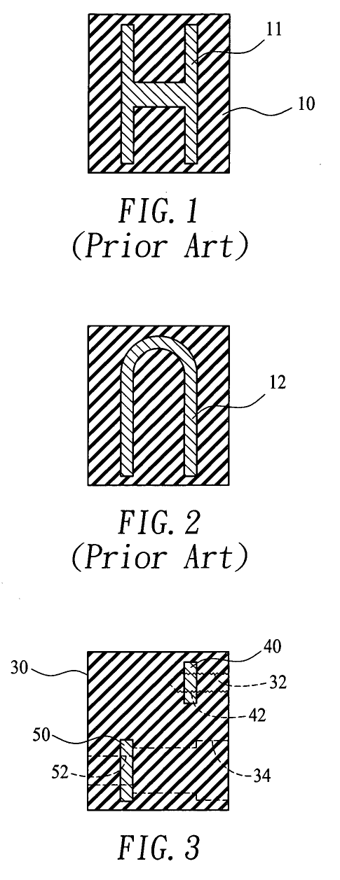

### DETAILED DESCRIPTION OF THE PREFERRED EMBODIMENTS

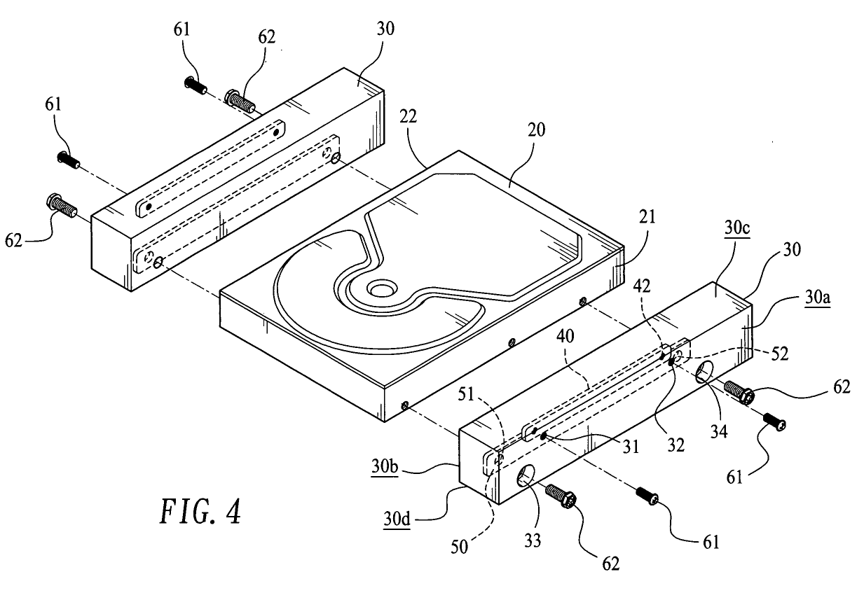

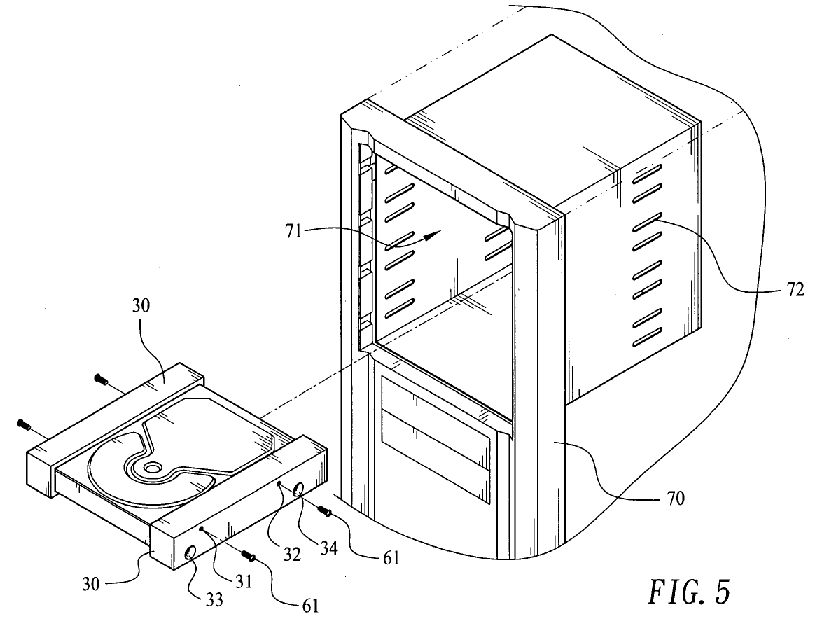

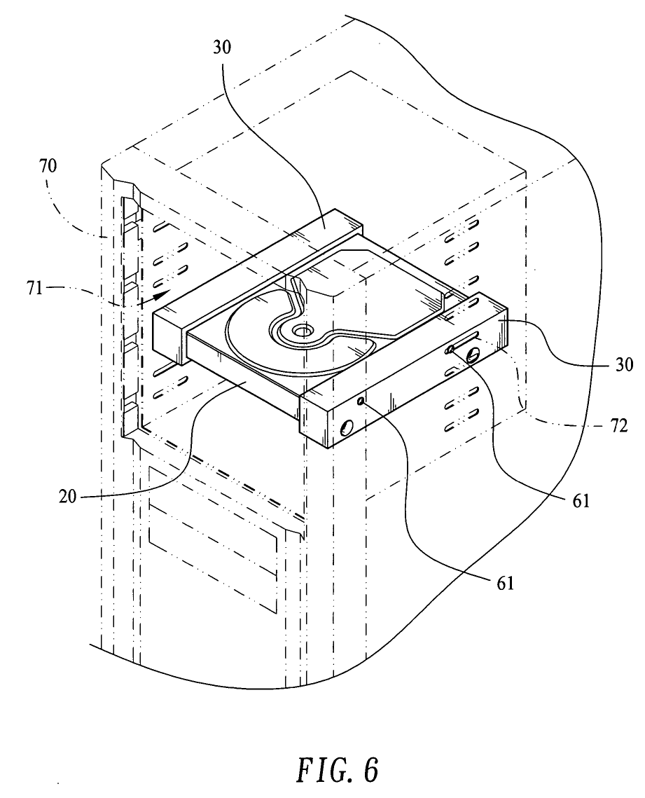

Please refer to FIGS. 3 and 4 in which a damping device for hard disk drive according to a preferred embodiment of the present invention is shown. In the illustrated preferred embodiment, the damping device includes two symmetrically identical cushion pads 30 for connecting to two lateral sides 21, 22 of a hard disk drive 20. Each of the two cushion pads 30 is a long bar having a substantially rectangular cross section, and includes an outer side 30a that is to be abutted on an inner wall surface of a computer case (see FIGS. 5 and 6), an inner side 30b that is to be abutted on the lateral sides 21, 22 of the hard disk drive 20, a top side 30c, and a bottom side 30d. A distance between the top and the bottom side 30c, 30d is slightly larger than a thickness of the hard disk drive 20.

Since the two cushion pads 30 are symmetrically identical to each other, only one of them will be described hereinafter. The cushion pad 30 has a main body made of an elastic material having a predetermined vibration-absorbing ability, such as silicon rubber. At least an upper and a lower reinforcing strip 40, 50 made of a metal material are separately embedded in the main body of the cushion pad 30 when the latter is molded. The main body of the cushion pad 30 is provided close to an upper area thereof with at least two spaced upper mounting holes 31, 32 extended from the outer side 30a toward the inner side 30b by a predetermined distance, and close to a lower area thereof with at least two spaced lower mounting holes 33, 34 extended from the outer side 30a to the inner side 30b. More specifically, the upper mounting holes 31, 32 end at positions at where the upper reinforcing strip 40 is located, and the lower mounting holes 33, 34 extend through the cushion pad 30 to end at the inner side 30b.

The upper reinforcing strip 40 is shorter than the lower reinforcing strip 50, and is located closer to the outer side 30a and the top side 30c. On the other hand, the lower reinforcing strip 50 is located closer to the inner side 30b and the bottom side 30d.

During fabrication in a manufacturing plant, the upper reinforcing strip 40 is provided near two outer ends with two threaded holes 41, 42 and the lower reinforcing strip 50 is provided near two outer ends with two through holes 51, 52 that are preferably two long slots. The upper and the lower reinforcing strips 40, 50 having threaded holes 41, 42 and through holes 51, 52, respectively, formed thereon are then embedded in the main body of the cushion pad 30 when the latter is molded.

The upper and the lower mounting holes 31, 32 and 33, 34 may also be preformed on the cushion pad 30 when the main body is molded. The upper mounting holes 31, 32 are pre-tapped or adapted to receive self-tapping screws. The lower mounting holes 33, 34 are preferably stepped holes having a diameter-expanded section at the outer side 30a and a diameter-reduced section at the inner side 30b of the main body, so that screws may be screwed into the lower mounting holes 33, 34 with head portions of the screws completely sunk in the diameter-expanded section of the lower mounting holes 33, 34.

A first set of screws 61 may be separately screwed into the upper mounting holes 31, 32 on the outer side 30a of the cushion pad 30 to engage with the threaded holes 41, 42 pre-formed on the upper reinforcing strip 40, and a second set of screws 62 may be separately screwed into the lower mounting holes 33, 34 on the outer side 30a of the cushion pad 30 through the through holes 51, 52 pre-formed on the lower reinforcing strip 50 to connect the cushion pad 30 to one lateral side of the hard disk drive 20.

Please refer to FIGS. 5 and 6. A computer case 70 defines a chamber 71 for the hard disk drive 20. Two sidewalls of the chamber 71 are provided with pre-formed mounting slots 72. To mount the hard disk drive 20 and the damping device of the present invention in the chamber 71 of the computer case 70, first extend the second set of screws 62 into the lower mounting holes 33, 34 through the through holes 51, 52 on the lower reinforcing strips 50 to engage with threaded holes correspondingly provided at two lateral sides of the hard disk drive 20, so as to connect the cushion pads 30 to two lateral sides of the hard disk drive 20, and then extend the first set of screws 61 through the mounting slots 72 on the sidewalls of the chamber 71 into the upper mounting holes 31, 32 of the cushion pads 30 to engage with the threaded holes 41, 42 on the upper reinforcing strips 40. The hard disk drive 20 having the damping device of the present invention connected to two lateral sides thereof is therefore assembled to the computer case 70.

With the above arrangements, any vibratory force produced by the hard disk drive 20 during operation thereof is first applied to the main body of the cushion pads 30 and the lower reinforcing strips 50 that are longer and located closer to the hard disk drive 20, and the upper reinforcing strips 40 that are shorter and located farther from the hard disk drive 20 serve as supplementary structures to bear the vibratory force. Since the upper and the lower reinforcing strips 40, 50 are separated from one another, they do not bear uniform force while absorbing the vibration produced by the operating hard disk drive 20. Therefore, the inherent elasticity and vibration-absorbing ability of the main bodies of the cushion pads 30 may be maintained.

Unlike the conventional damping devices for hard disk drive that have integrally formed reinforcing members embedded in the cushion pads to bear the same vibratory force as the main bodies of the cushion pads and transfer the vibratory force to the computer case to produce undesired noises, the present invention enables the main bodies of the cushion pads to maintain their elasticity and vibration-absorbing ability to effectively reduce the noise produced by the operating hard disk drive.

The present invention has been described with some preferred embodiments thereof and it is understood that many changes and modifications in the described embodiments can be carried out without departing from the scope and the spirit of the invention that is to be limited only by the appended claims.

1. A damping device for hard disk drive, comprising two symmetrically identical cushion pads made of an elastic material for connecting to two lateral sides of a hard disk drive;
each of said two cushion pads including a main body having an outer side that is to be abutted on an inner wall of a computer case, an inner side that is to be abutted on one lateral side of said hard disk drive, a top side, and a bottom side, a distance between said top and said bottom side being slightly larger than a thickness of said hard disk drive; and at least an upper and a lower reinforcing strip made of a metal material separately embedded in said main body of said cushion pad when the latter is molded;
said main body of said cushion pad being provided on said outer side with at least two spaced upper mounting holes extended toward said upper reinforcing strip, and at least two spaced lower mounting holes extended from said outer side through said lower reinforcing strip to said inner side; and
said cushion pads being connected to two lateral sides of said hard disk drive using a first and second sets of screws; said second set of screws being threaded into said lower mounting holes on said outer side of said main body of each said cushion pad to engage with screw holes correspondingly provided on two lateral sides of said hard disk drive, so as to connect said cushion pad to the lateral side of said hard disk drive; and said first set of screws being threaded through mounting slots provided on said inner wall of said computer case into said upper mounting holes on each said cushion pad to engage with said upper reinforcing strip, so as to fix said hard disk drive and said damping device to said computer case.

2. The damping device for hard disk drive as claimed in claim 1, wherein said upper reinforcing strip is located closer to said outer side and said top side of said main body of each said cushion pad, and said lower reinforcing strip is located closer to said inner side and said bottom side of said main body of each said cushion pad.

3. The damping device for hard disk drive as claimed in claim 1, wherein said upper reinforcing strip is shorter than said lower reinforcing strip.

4. The damping device for hard disk drive as claimed in claim 2, wherein said upper reinforcing strip is shorter than said lower reinforcing strip.

5. The damping device for hard disk drive as claimed in claim 1, wherein said upper reinforcing strip is provided at positions corresponding to said upper mounting holes with threaded holes.

6. The damping device for hard disk drive as claimed in claim 1, wherein said lower mounting holes are stepped holes extended from said outer side of said main body of each said cushion pad to end at said inner side of said main body.
